(19) United States
(12) Patent Application Publication
(10) Pub. No.: US 2013/0106289 A1
(43) Pub. Date: May 2, 2013

(54) SAFETY HARNESS

(71) Applicants: Brad BENESKI, Austin, TX (US); Paul MORGENSTERN, Austin, TX (US)

(72) Inventors: Brad BENESKI, Austin, TX (US); Paul MORGENSTERN, Austin, TX (US)

(21) Appl. No.: 13/284,724

(22) Filed: Oct. 28, 2011

(51) Int. Cl. H05B 37/02

(52) U.S. Cl. 315/121; 315/210

(57) ABSTRACT

A novel safety harness is disclosed. The safety harness has straps for securing upon a subject. Arranged around the straps are several light emitting diodes (LEDs). The LEDs are driven by pulses of current that exceed the power rating of the LED, but the current is driven for a very short period of time, such that the LEDs are not destroyed. These LEDs blink when turned on and emit substantially more light than is typically found in LEDs, such that the subject is visible from a distance of up to two thousand feet. Multiple safety harnesses may be strapped together, allowing the safety device to be used in a variety of settings, both for human and non-human subjects.

### CROSS-REFERENCE TO RELATED APPLICATIONS

This application claims priority to U.S. application Ser. No. 12/207,035, filed on Sep. 9, 2008.

### TECHNICAL FIELD

This application relates to safety harnesses and, more particularly, to a portable illuminating safety harness.

### BACKGROUND

Cyclists (e.g., bicyclists or motorcyclists), pedestrians, skaters, and the like (hereinafter, “subject” or “subjects”) are often injured by motor vehicles. In many cases, the driver of a motor vehicle fails to see the subject in time to avoid striking or nearly striking the unfortunate victim. The subject is simply not sufficiently visible to the driver.

The problem is particularly acute at night. Some individuals use one or more standard bike lights, so as to be visible to others after dark. The bike lights may be reflectors, such as those connected to spokes or pedals of the bike, or they may be self-powered (battery-operated) lights. For the pedestrian or the skater, the bike lights may be strapped to a belt loop or a backpack, for example. The bike lights may be light emitting diodes (LEDs), which produce between 1,000 and 7,000 millicandles (MCDs) of light. Such lights are typically only visible for about fifty feet. Where the subject is traveling where cars are present, the visibility may be inadequate.

Thus, there is a continuing need for a safety device that allows a subject to safely be visible to others particularly after dark.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a diagram of a safety harness, according to some embodiments;

FIG. 2 is a diagram of three alternative arrangements of the safety harness of FIG. 1, according to some embodiments;

FIG. 3 is a circuit used by the safety harness of FIG. 1 to power the LEDs, according to some embodiments;

FIG. 4 is a second circuit used by the safety harness of FIG. 1 to power the LEDs, according to some embodiments;

FIG. 5 is a third circuit used by the safety harness of FIG. 1 to power the LEDs, according to some embodiments; and

FIG. 6 is a flow diagram showing operations of the circuit to power the LEDs in the safety harness of FIG. 1, according to some embodiments.

### DETAILED DESCRIPTION

In accordance with the embodiments described herein, a novel safety harness is disclosed. The safety harness has straps for securing upon a subject. Arranged around the straps are several light emitting diodes (LEDs). The LEDs are driven by pulses of current that exceed the power rating of the LED, but the current is driven for a very short period of time, such that the LEDs are not destroyed. The LEDs blink when turned on and emit substantially more light than is typically found in LEDs, such that the subject is visible from a distance of up to two hundred feet. Multiple safety harnesses may be strapped together, allowing the safety device to be used in a variety of settings, both for human and non-human subjects.

In the following detailed description, reference is made to the accompanying drawings, which show by way of illustration specific embodiments in which the inventive concepts disclosed herein may be practiced. However, it is to be understood that other embodiments will become apparent to those of ordinary skill in the art upon reading this disclosure. The following detailed description is, therefore, not to be construed in a limiting sense, as the scope of the invention is defined by the claims.

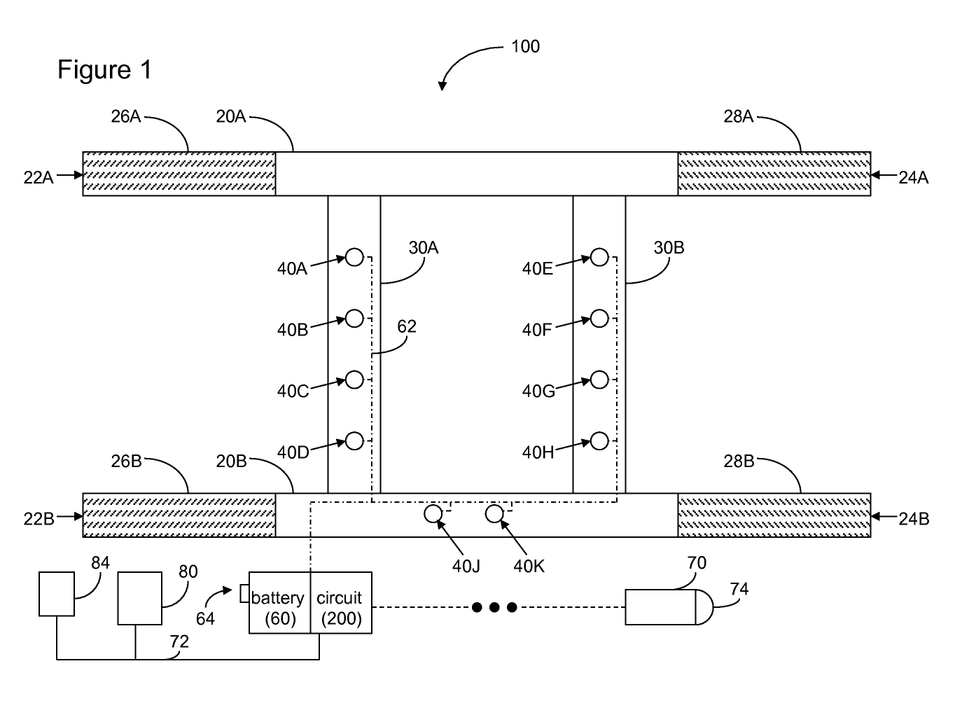

FIG. 1 is a diagram of a safety harness 100, according to some embodiments. The safety harness 100 is composed of straps upon which light emitting diodes (LEDs) are disposed. In FIG. 1, there are two horizontally disposed straps 20A and 20B (collectively, horizontal straps 20) and two vertically disposed straps 30A and 30B (collectively, vertical straps 30). LEDs 40A, 40B, . . . 40K (collectively, LEDs 40) are positioned strategically around the safety harness 100 so as to maximize visibility when the safety harness 100 is worn by a subject. The LEDs 40 may be sewn or otherwise affixed to the straps 20, 30 in a manner other than is shown in FIG. 1, which shows more LEDs coupled to the vertical straps 30 than to the horizontal straps 20.

In some embodiments, when the LEDs are turned on, the safety harness 100 may be visible from a distance of 200 feet or more. In other embodiments, the LEDs are visible from a distance of almost 2000 feet. This increased visibility may give drivers the additional time needed to avoid hitting the subject.

In some embodiments, the safety harness 100 is affixed directly to the subject. The safety harness 100 may thus be worn over clothing, such as riding clothes, bulky winter wear, such as ski clothing, military uniforms, government uniforms, such as for mail carriers, policemen/women, school crossing guards, and the like, construction worker gear, scuba air tanks, and so on. In some embodiments, the safety harness 100 is made with a waterproof or water resistant material, so as to be used in water environments. The versatility of the safety harness 100 makes it useful for adding safety features to existing uniforms at a reasonable cost.

In other embodiments, the safety harness 100 is affixed to an item connected to the subject, such as a backpack, a water pack, a purse, a skate, a boot, a hat, or even to a bicycle. The straps 20, 30 are adjustable, enabling the safety harness 100 to readily be secured to a variety of objects. The safety harness may safely be used with non-human subjects, such as dogs or horses.

In FIG. 1, the horizontal strap 20A includes an end 22A and an opposing end 24A, while the horizontal strap 20B includes an end 22B and an opposing end 24B (collectively, ends 22 and 24). The ends 22, 24 are connection means for securing the safety harness 100 to the subject or connected object. The end 22A is to be removably coupled to the end 24A while the end 24B is to be removably coupled to the end 24B. In some embodiments, the connection means are Velcro attachment pieces, with a “hook” side being disposed on the end 22 and a “loop” side being disposed on the end 24 (or vice-versa). (Velcro is a registered trademark of Velcro, Inc., of Manchester, N.H.) Alternatively, the connection means may employ snaps, buttons, zippers, ties, or other connecting means. Designers of ordinary skill in the art recognize a variety of mechanisms by which the ends 22, 24 of the horizontal straps 20 may be connected together.

In some embodiments, the straps 20, 30 are made of a durable, man-made or natural fiber material that is resistant to tearing. The material may be synthetic, such as acrylic, leatherette, polyester, spandex, or nylon netting, a natural fiber, such as cotton, corduroy, denim, duffel, linen, net, or mesh, a leather material, such as material used to make belts, durable material, such as canopy, tent, or sailcloth, uniform material, such as chino or khaki, cold-weather fabric, such as fleece, to name a few possibilities, as well as combinations of these materials. With this versatility, the safety harness 100 may be customized to include materials appropriate to its intended use.

In the case of non-fiber materials, the straps 20, 30 of the safety harness 100 are made of a flexible, stretchable elastomeric material, such as deformable plastic used in some toys. In such an arrangement, the straps 20, may be affixed to the subject without connecting means, but are instead stretched and twisted or wrapped around each other after securing to the subject, in a manner similar to a twist tie.

The LEDs 40 are driven by circuitry (not shown) that creates highly visible lighting. The circuitry is described in more detail, below. The LEDs 40 may be blinking, flashing, or otherwise illuminated, and may come in a variety of colors. In some embodiments, the LEDs 40 produce illumination in the range of 1,000 to 70,000 MCDs, such that the LEDs are visible in sunlight or at night. Depending on how the safety harness 100 is worn, the LEDs 40 may be visible from the front or the back of the subject.

In some embodiments, the safety harness 100 is wrapped around a backpack, water pack, or other object worn or held by the subject such that the horizontal straps 20 form a cylinder or loop around the object. In this manner, the vertical straps 30 are visible on one side of the object. Where the object is a backpack, for example, worn on the subject's back, the subject may readily be observed from behind. Many people wear backpacks on their front, so the safety harness 100 may alternatively identify the front of the subject. In other embodiments, the safety harness 100 is large enough to be strapped around the subject's torso, with the ends 26 being coupled to the ends 28 at the back or at the front of the subject.

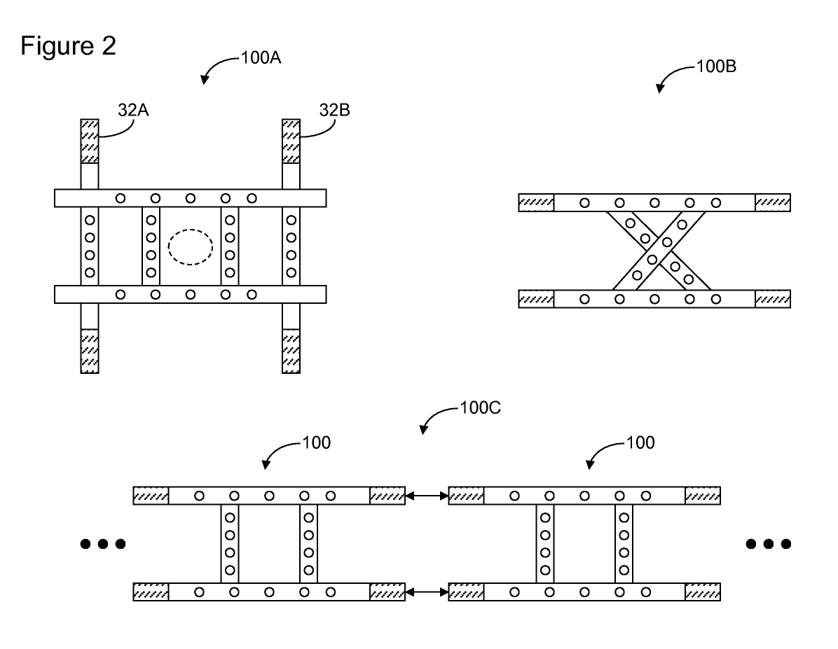

FIG. 2 includes diagrams of three alternate arrangements of the safety harness 100, according to some embodiments. The safety harness 100A includes a third pair of straps 32A, 32B disposed orthogonal to the horizontal straps 26. This arrangement allows the safety harness 100A to be placed over the head of the subject (see dotted circle) such that the vertical straps 30 are disposed horizontal on the front and back of the subject, with attachment means being located on the straps 32A, 32B. In this configuration, the horizontal straps 20 would be arranged over the shoulders of the subject. The safety harness 100B has the formerly vertical strips 30 arranged in an X configuration. The safety harness 100C is actually a combination of two or more safety harnesses 100. The safety harness 100C may be used on larger persons or on non-human objects, such as the back of a pickup truck, a boat, a parade float, a safety vehicle, and so on. Designers of ordinary skill in the art recognize a number of different arrangements for the safety harness 100.

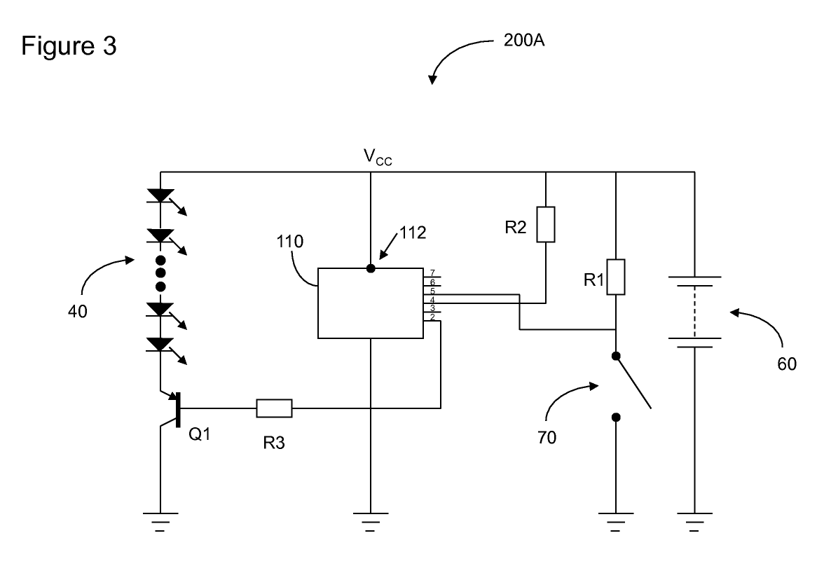

Returning to FIG. 1, the safety harness 100 includes a circuit 200, which is connected to the LEDs 40 by a cable or dongle 62, according to some embodiments. The circuit 200 is powered by a battery 60, which selectively feeds current to the LEDs 40, enabling them to illuminate. The battery 60 may be disposed beneath one of the straps 20, 30, such that it is not visible when the safety harness 100 is worn. Connected to the circuit by traces 62, the LEDs 40 are part of the circuit 200. In some embodiments, the battery 60 and circuit 200 are housed together. In other embodiments, the circuit 200 is sewn into one of the straps 20 or 30, while the battery 60 remains external to the straps, but still connected to the circuit. The circuit 200 is described in more detail in FIGS. 3, 4, and 5. The battery 60 may include a master ON/OFF switch 64 that is accessible to the subject, enabling the subject to control when the LEDs 40 are illuminated. When the switch 64 is in a first state (e.g., engaged), the battery 60 supplies power to the circuit 200, which supplies current to the LEDs 40; when in a second state (e.g., disengaged), the LEDs receive no current. The switch 64 may be disengaged, for example, when the safety harness 100 is being stored, ensuring that the LEDs will not be accidentally turned on. Where the safety harness 100 is to be used in a water environment, the circuit 200 and battery 60 may be encased in a rubber housing.

In some embodiments, the safety harness 100 also includes a switch 70, which is connected to the LEDs by a cable or dongle 72. The cable or dongle 72 is long enough for the subject to wear the safety harness 100 on her back, while the switch 70 is available in front of her body. The switch 70 is a push-button switch that operates a processor within the circuit 200. In some embodiments, when the switch 70 is pushed, the LEDs 40 are in a first power state; when the switch is again pushed, the LEDs are in a second power state. The subject can enable or disable the LEDs 40 using the switch 70. The switch 70 may itself include an LED 74, whose illumination tracks the illumination of the LEDs 40. In other words, when the LEDs 40 are on, the LED 74 is on, and vice-versa.

The LEDs 40 may be different colors. In some embodiments, the LEDs 40A-40H are red while the LEDs 40J, 40K are white. In other embodiments, the LEDs are arranged in three different colors. As is described below, red LEDs may be illuminated or pulsed (without illuminating the white LEDs), based upon an input from a processor in the circuit 200 and a sensor 80, in which the sensor (e.g., an accelerometer) detects the position of the subject. In FIG. 1, the battery 60 and circuit 200 are located inside one of the horizontal strips 20 and are connected to the LEDs 40 by the cable 62. The sensor 80 is external to the circuit 200, but connected thereto. In other embodiments, the sensor 80 is wirelessly able to communicate with the processor of the circuit 200. The sensor 80 may detect that the subject is not in a substantially vertical position, such as when the subject has fallen. Based on the sensor data, the LEDs may illuminate or flash. Or, the sensor 80 may detect that the subject has stopped moving. In contrast to the arrangements shown in FIGS. 1 and 2, the LEDs may be positioned differently, such as in an octagonal arrangement, so as to represent a stop sign, a reverse triangle arrangement, as in a yield sign, and so on.

In some embodiments, the LEDs 40 are separated into two groups, group A (e.g., LEDs 40A, 40B, 40C, 40D and 40J) and group B (e.g., LEDs 40E, 40F, 40G, 40H, and 40K). On detecting motion, the sensor 80 notifies the processor, at which point the LEDs in group A may illuminate while LEDs in group B are turned off, as one example. Or, the LEDs may pulse to indicate a direction of travel. The LEDs in group A may illuminate when the subject is turning left and while the LEDs in group B illuminate when the subject is turning right. In this manner, the safety harness 100 emulates the left and right turn blinkers on an automobile. In some embodiments, the sensor 80 is a tilt sensor, such as the Omron Electronic Components, Model #D7E-3, mercury switch, bubble sensor, accelerometer, by Analog Devices, Model #ADIS16003CCCZ.

In some embodiments, the sensor 80 may indicate a sudden and dramatic change in speed, such as when the subject crashes. Upon such a sudden change, the sensor 80 sends an input to the processor (not shown), which may change the display orientation of the LEDs 40 (e.g., increase pulse or blink rate, alternate illumination of red and white LEDs, and so on). Further, a signal similar to the input sent to the processor may be sent to a transmitter (not shown), which processes the signal as an SOS (emergency) signal. The SOS signal may be a radio frequency signal, which could be communicated to an emergency services receiver.

In some embodiments, the sensor 80 is a speed sensor, such as the Allegro ATS642 Hall Effect sensor, coupled with a Reynolds Electronics TWS-434A transmitter. In this configuration, the sensor 80 indicates when the subject is traveling at a rate less than or more than a predetermined rate, such as ten miles per hour (mph). Upon receipt of the signal from the sensor 80, the processor may illuminate the LEDs 40 at a slow pulse rate. However, if the speed sensor 80 indicates that the subject is traveling at a speed higher than the predetermined rate but less than a second predetermined rate, such as between ten and twenty miles per hour, the processor may pulse the LEDs 40 at an accelerated rate. Further, if the sensor determines that the subject is traveling faster than the second predetermined rate, such as more than twenty miles per hour, the processor may illuminate the LEDs 40 at a very accelerated rate. The LEDs are thus pulsed at a speed that varies, depending on the speed of the subject. Beyond the obvious safety aspects, the variably pulsed LEDs 40 are entertaining for a subject entered in a bicycle race, as the LEDs provide an indication of the subject's relative speed.

As indicated above, the sensor 80 of the safety harness 100 may be a wireless sensor, which communicates wirelessly with the circuit 200. The sensor 80A may be mounted to a front wheel of a bicycle, as one example. Communication between the sensor 80A and the circuit 200 is known to those of ordinary skill in the art. In some embodiments, a speed sensor consisting of a small magnet mounted on the wheel of a bicycle magnetically couples to a magnetic switch mounted on the bicycle frame. The measured speed would be a function of the revolutions per minute of the wheel, as detected by the sensor. In some embodiments, the safety harness 100 utilizes a Hamlin Electronics switch #59025-030, a Hamlin electronics magnet #57020-000, a Radiotronix #RCT-315-AS transmitter, and a Radiotronix RCR-315_RP receiver.

In some embodiments, the safety harness 100 includes a light (photo) sensor 84 connected to the processor. The light sensor 84 detects the amount of light being received by the subject. When detecting an abundance of light, such as sunlight, over a prolonged period of time, the light sensor 84 reports this information to the circuit 200, which then adjusts the illumination of the LEDs 40 based on this information. For example, the MCDs of the LEDs may be decreased during very sunny conditions or increased at night, with the increases/decreases being sufficient to maintain visibility of the subject from a great distance, such as 200 feet or more. By enabling the illumination of the harness to be varied strategically, the light sensor 84 may thus extend the battery life of the safety harness 100. In some embodiments, the light sensor 84 is a Honeywell Model #SD5620-001 photo detector, a Fairchild Model #QSE159E3R0 photo sensor, an Advanced Photonix Inc. Model #PDV-V417 photodiode.

The LEDs 40, battery 60, and switch 70 of the safety harness 100 are part of the circuit 200. FIGS. 3, 4, and 5 are three different depictions of the circuit 200 used by the safety harness 100 of FIG. 1. The LEDs are solid-state devices. Electrically, LEDs are diodes. Diodes conduct or pass current at a certain threshold voltage. Below the threshold voltage, no current flows, as the diode blocks the flow of current. Above the threshold voltage, current flows through the diode. The current, if not controlled in some manner, will continue to increase until the diode is destroyed. Since the LED is a diode, these principles apply to the LED as well. Once the LED is turned on, if nothing is put in the path of the current to stop its flow, the LED will eventually be destroyed by the increasing current flow.

The inside of a LED is a solid-state junction. Passing current through the junction creates light, causing the LED to light up. If the temperature at the junction, known as the junction temperature, exceeds a certain temperature, the LED will be destroyed. Typically, the junction temperature is controlled using a resistor, which limits the current entering the LED. LED circuits thus typically include the LED and at least one resistor. A formula is used to calculate the resistor value for a given voltage and LED. The maximum amount of current that the LED can safely handle is based on its junction temperature.

However, it is possible to limit the current also using time. That is, by limiting the amount of time current flows to the LED, the junction temperature is maintained at a safe level. Such a LED circuit would possibly include no resistor to limit current being fed to the diode (LED). In some embodiments, the LEDs 40 of the safety harness 100 are time-limited, rather than current-limited LEDs. The LEDs receive more than ten times the rated current (the current recommended by the manufacture of the LED for prolonged life) for a predetermined period of time, then turned off for approximately ten times that predetermined period. The current flows for a short enough period that the junction temperature is not exceeded. The result is that the LEDs 40 burn much more brightly than typical LEDs, making the safety harness 100 safer than safety lights that are currently available. In some embodiments, the LEDs are turned on for 10 to 65 ms, then they are turned off for 100 to 650 ms. In other embodiments, the LEDs are turned on for 20 to 35 ms, then are turned off for 200 to 350 ms. By turning OFF the LED for a relatively longer time compared to the ON time, the average junction temperature of the LED remains a level that is safe for the LED.

LEDs typically have a manufacture-specified power rating. Users of the LED are cautioned not to exceed the power rating. In some embodiments, the LEDs 40 of the safety harness 100 exceed the power rating by up to ten times that which has been specified by the manufacturer. Circuit designers typically include a resistor in the circuit so as to ensure that the power rating of the LEDs is not exceeded during use. The LEDs 40 of the safety harness 100, however, do exceed the power rating of the manufacturer. Nevertheless, the LEDs do not burn up because the excess power is supplied for a very brief period of time, which generally does not exceed 35 ms. In some embodiments, the average power delivered to the LEDs 40 in the circuit 200 ranges from 0 to 2.3 Watts.

In some embodiments, the circuit 200 of the safety harness 100 includes a receiver and/or a transceiver. The receiver may receive a signal from a remote transmitter. Upon receiving the signal, the LEDs 40 may illuminate. With this configuration, the safety harness 100 may be beneficial in search and rescue situations. For example, a search team may be outfitted with safety harnesses 100. If one team member is missing or lost, another team member may enable an activation signal, which may be received by the lost individual, thereby illuminating his or her array of LEDs.

Further, the LEDs 40 may be infrared LEDs, such as a Fairchild #QED123 infrared device. Such devices are highly visible to certain night vision goggles and cameras. A transceiver, such as a Linx Technologies TRM-315-LT, may be incorporated into the safety harness 100, with a compatible transceiver being used by the rescue services team. When the rescue team activates the transceiver, the transmitter transmits a signal to the safety harness 100. The safety harness 100 may then activate (e.g., flash) the infrared LEDs, as well as the visible (non-infrared) LEDs. Additionally, the safety harness 100 may transmit a location signal that could be received by the rescue team, thereby allowing the rescuers to triangulate on the lost subject.

FIG. 3 is a circuit diagram 200A used by the safety harness 100 of FIG. 1, according to some embodiments. A circuit 200A with a processor 110 is operatively coupled to a series of LEDs 40 (LED array) (of variable length) via node 112 (V_{CC}). The processor 110 is coupled to transistor Q1 via resistor R3. Each circuit may receive power from the battery 60 (e.g., AA batteries) at, for example, 4.5 volts. The circuit may be turned ON/OFF via the switch 70; when the switch is turned ON, the LEDs 40 blink. In some embodiments, the processor 110 is a PIC12F675 microprocessor and the switch 70 is a push-button switch. Software on the microprocessor may determine the timing characteristics of the output pulse delivered to the transistor Q1. The transistor Q1 may be biased ON by the negative going or positive going transition of the output pulse from node 2 on the processor 110.

The circuit 200A may include numerous resistors R1, R2, R3. In some embodiments, R1 is a 10 kilo-ohm (K) resistor, R2 is a 10K resistor, and R3 is a 49-ohm resistor. However, none of these resistors are in the path of current fed to the LEDs 40, and, thus, do not limit the current supplied to the LEDs.

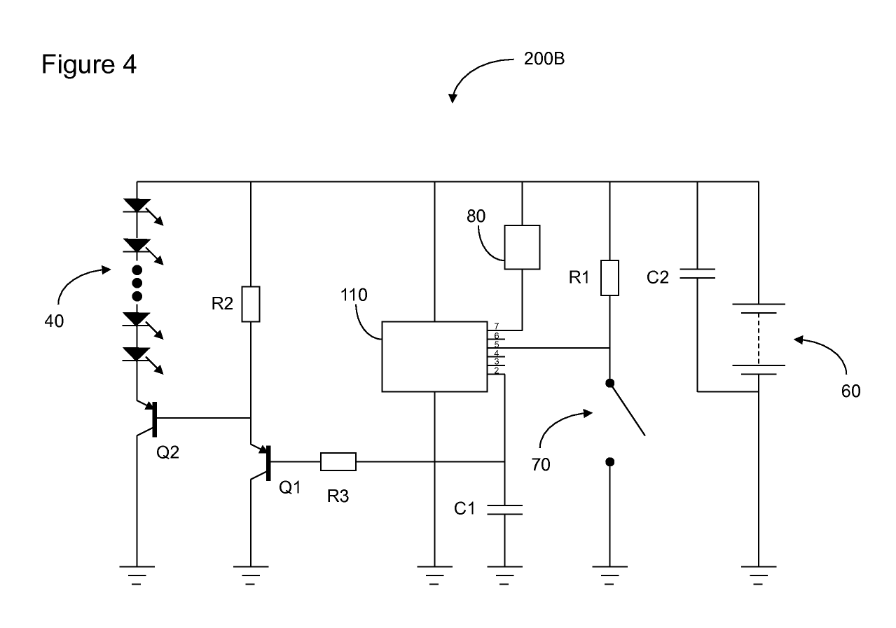

FIG. 4 is another circuit diagram 200B that alternatively may be used by the safety harness 100 of FIG. 1, according to some embodiments. The circuit 200B operates in a manner similar to the circuit 200A (FIG. 3), except that the circuit 200B has an extra transistor Q2 to drive the LEDs. The transistor Q1 turns transistor Q2 on and off, which, in contrast to the circuit 200A, enables much more power to be delivered to the LEDs 40. The circuit 200B also includes the battery 60 and the switch 70, as in FIG. 1. The optional sensor 80 is coupled to the processor 110. Alternatively, the light sensor 84 may be part of the circuit 200B, in place of the sensor 80. The specific operation of the circuit 200B is ascertainable to those of ordinary skill in the art and will not be specifically addressed herein.

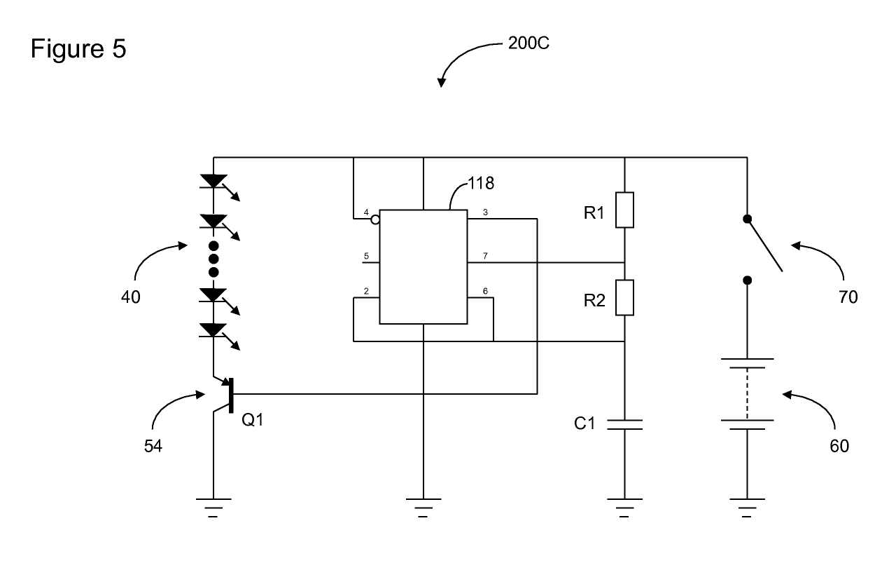

FIG. 5 is a third circuit diagram 200C that alternatively may be used by the safety harness 100 of FIG. 1, according to some embodiments. Like the circuit 200A (FIG. 3), the circuit 200C includes the variable-length LED array 40. However, instead of a microprocessor, the circuit 200C employs a 555-timer integrated circuit 118. Powered by the battery 60, the 555 timer 118 (manufacturer part number LM555CN/NOPB) generates a pulse of programmable duration. The resistors R1, R2, and capacitor C1 form a timing circuit electronically, to control the ON time and the OFF time of the pulse sent to the LEDs 40.

Multiple resistors R1, R2, R3, and a capacitor C1 are also depicted in FIG. 5. Resistor and capacitor values may determine the timing characteristics of the output pulse. As with the circuits 200A and 200B, the resistors are not disposed in the path where current flows to the LEDs 40. Therefore, the resistors do not limit the current flow to the LEDs in any way. In some embodiments, resistor R1 is 10K ohms, resistor R2 is 4.7K ohms, resistor R3 is 324 ohms, and capacitor C1 is 10 nano-Farads (nF). The output pulse on node 3 of the 555 timer controls the base of the PNP (p-type) transistor Q1. Other forms of transistors, such as NPN (n-type) and metal oxide semiconductor field effect (MOSFET) transistors, may optionally be used in the circuit 200C instead of the p-type transistor. The transistor Q1 may be biased by a negative-going transition of an output pulse from node 3 of the timer 118. In some embodiments, the transistor Q1 is biased ON by a positive-going pulse. The battery 108 is preferably a 4.5V battery, which may be made up of three cells at 1.5 volts each. In some embodiments, the pulse width at the LED array 40 is approximately 24 milliseconds and the frequency of the pulse train is approximately 5 Hertz (Hz). The pulse characteristics are approximately 24 milliseconds (ms) in the ON mode and 200 ms in the OFF mode, in some embodiments. In some embodiments, the manufacturer part number of the LED array 40 is LTL-2F3VYKNT. Engineers of ordinary skill in the art will recognize that a variety of different transistors may be used in the circuits 200A, 200B, or 200C.

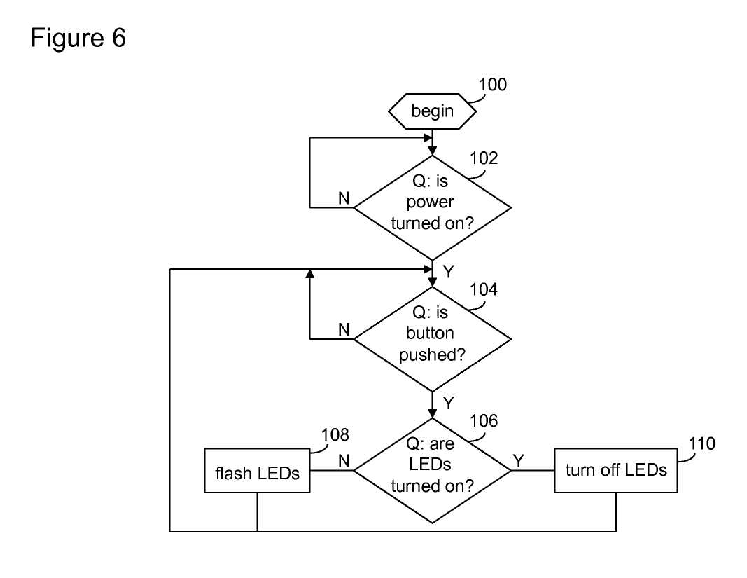

FIG. 6 is a flow diagram showing operations of the safety harness 100, according to some embodiments. The LEDs 40 of the safety harness 100 will not work without a power source. In FIG. 1, the power source is the battery 60. If the battery is not turned on (block 102), the LEDs 40 do not light up. Further, until the push-button switch 70 is turned on (block 104), the LEDs do not light up. Since the push-button switch 70 is a push-button (momentary) contact device, a first push of the switch causes the LEDs 40 to be in a first state while the second push causes the LEDs to be in a second state. Assuming the first state is ON, the LEDs 40 will flash when the push-button switch 70 is first pushed (block 108). A second push of the switch 70 causes the LEDs 40 to turn off (block 110). The switch 70 may be repeatedly pushed in this manner, with the LED 74 indicating the state of the LEDs 40 to the subject. Once the switch 64 of the battery 60 is turned off, the LEDs 40 of the safety harness 100 no longer flash.

Thus, the safety harness 100 features a circuit that pulses the LEDs 40 at ten times the typical current, but does so for short enough pulses that the LEDs are not destroyed. The result is much brighter burning LEDs that do not deteriorate quickly, but instead last as long as prior art LEDs.

While the invention has been described with respect to a limited number of embodiments, those skilled in the art will appreciate numerous modifications and variations therefrom. It is intended that the appended claims cover all such modifications and variations as fall within the true spirit and scope of the invention.

We claim:

1. A circuit, comprising:
a microprocessor connected to a power source; and
a plurality of light-emitting diodes having a predetermined power rating, the microprocessor, when receiving power from the power source, to supply a pulse of current to the light-emitting diodes as follows:
supplying current exceeding the power rating of the light-emitting diodes for a predetermined time period; and
supplying no current to the light-emitting diodes for at least ten times the predetermined time period; and
a transistor whose gate is connected to an output of the microprocessor,
wherein the transistor drives the plurality of light-emitting diodes;
wherein the plurality of light-emitting diodes do not break.

2. The circuit of claim 1, further comprising:
a switch coupled between the power source and the microprocessor, wherein the switch turns the microprocessor ON and OFF.

3. The circuit of claim 1, wherein the predetermined time period is at least 10 milliseconds but not more than 65 milliseconds.

4. The circuit of claim 1, wherein the light-emitting diodes, when powered on, are visible from 2000 feet.

5. The circuit of claim 1, wherein the microprocessor is a PIC12F675 microprocessor and the power source is a 4.5-volt battery.

6. The circuit of claim 1, wherein the predetermined time period is between 20 and 35 milliseconds.

7. A circuit, comprising:
a microprocessor connected to a power source;
a plurality of light-emitting diodes having a predetermined power rating, the microprocessor, when receiving power from the power source, to supply a pulse of current to the light-emitting diodes as follows:
supplying current exceeding the power rating of the light-emitting diodes for a predetermined time period; and
supplying no current to the light-emitting diodes for a second predetermined time period;
a transistor to drive the plurality of light-emitting diodes, wherein an emitter of the transistor is coupled to one end of the plurality of light-emitting diodes;
a second transistor whose gate is coupled to an output of the microprocessor and whose emitter is coupled to a gate of the first transmitter,
wherein collectors of both transistors are coupled to ground;
wherein the plurality of light-emitting diodes do not break.

8. The circuit of claim 7, further comprising:
a capacitor coupled between the microprocessor and a ground;
a resistor coupled between an output of the microprocessor and the plurality of light-emitting diodes.

9. The circuit of claim 7, further comprising:
a sensor disposed between an output of the microprocessor and the plurality of light-emitting diodes, the sensor to sense a position of the circuit, wherein the sensor blocks current to the plurality of light-emitting diodes when the circuit is in a predefined position.

10. The circuit of claim 7, further comprising:
a light sensor disposed between an output of the microprocessor and the plurality of light-emitting diodes, the light sensor to sense a the amount of ambient light near the circuit, wherein the light sensor blocks current to the plurality of light-emitting diodes when a predetermined amount of ambient light has been obtained.

11. The circuit of claim 7, wherein the microprocessor is a PIC12F675 microprocessor and the power source is a 4.5-volt battery.

12. The circuit of claim 7, wherein the predetermined time period is twenty-four milliseconds and the second predetermined time period is two hundred milliseconds.

13. The circuit of claim 11, wherein the predetermined time period is ten milliseconds and the second predetermined time period is one hundred milliseconds.

14. The circuit of claim 11, wherein the predetermined time period is sixty-five milliseconds and the second predetermined time period is six hundred fifty milliseconds.

15. A circuit, comprising:
a timer connected to a power source, the timer to generate a pulse of programmable duration; and
a plurality of light-emitting diodes having a predetermined power rating, the timer, when receiving power from the power source, to supply a pulse of current to the light-emitting diodes as follows:
supplying current exceeding the power rating of the light-emitting diodes for a predetermined time period; and
supplying no current to the light-emitting diodes for a second predetermined time period; and
a transistor whose gate is connected to an output of the microprocessor, the transistor to drive the plurality of light-emitting diodes;
wherein the plurality of light-emitting diodes do not break.

16. The circuit of claim 15, further comprising:
a first resistor coupled between the plurality of light-emitting diodes and an output of the timer;
a capacitor coupled between a second output of the timer and a ground; and
a second resistor coupled between the output of the timer and the capacitor, wherein the first resistor, the second resistor, and the capacitor form a timing circuit to control the on and off time of the pulse of current sent to the plurality of light-emitting diodes.

17. The circuit of claim 16, wherein the resistor is a ten kilo-ohm resistor, the second resistor is a 4.7 kilo-ohm resistor, and the capacitor is a 10 nano-Farad capacitor.

18. The circuit of claim 15, wherein the power source is a 4.5-volt battery.

19. The circuit of claim 15, wherein the predetermined time period is twenty-four milliseconds and the second predetermined time period is two hundred milliseconds.

20. The circuit of claim 15, wherein the timer is an LM555CN/NOPB 555 timer.
